(19) United States
(12) Patent Application Publication
(10) Pub. No.: US 2016/0173950 A1
(43) Pub. Date: Jun. 16, 2016

(54) THIRD WITNESS VIDEO PARTICIPATION SYSTEM AND METHOD

(71) Applicant: Virtual Health Systems Corporation, Hamilton, NJ (US)

(72) Inventor: Jacob T. Brown, JR., Hamilton, NJ (US)

(21) Appl. No.: 14/967,272

(22) Filed: Dec. 12, 2015

Related U.S. Application Data
(60) Provisional application No. 62/091,019, filed on Dec. 12, 2014.

(51) Int. Cl. H04N 21/4788; G11B 27/36; H04N 5/44; H04N 5/77; H04N 5/225

(52) U.S. Cl. CPC H04N 21/4788; H04N 5/77; H04N 5/2252; H04N 5/44; G11B 27/36

(57) ABSTRACT

A video recording and law enforcement corroboration process. A video feed is established between a law enforcement officer and a perpetrator, initiated by either party. Participation by a corroborating third party is then invited and the video feed is shared, wherein an interaction between the law enforcement officer and the perpetrator is both documented and corroborated. The feed being recorded thereby forms a record which can be sent to a central processing unit, thereby forming an event record, wherein the event record can be stored and used in criminal proceedings as it relates to the perpetrator. Structurally, the system includes a video recording and law enforcement corroboration system, comprising a cap to be worn by a user; a clip strip mounted on the cap; a wireless camera accessory secured to the clip strip; and, a harness to be worn by the user for mounting additional wireless camera accessories.

### CROSS REFERENCE TO RELATED APPLICATIONS

The instant application claims benefit of provisional application Ser. No. 62/091,019, filed Dec. 12, 2014, which is incorporated herein by reference.

### BACKGROUND

In addition to allegations of graft, corruption and the use of excessive force, recent shootings of unarmed victims have exacerbated the mistrust between Law enforcement and various segments of the Public; this is especially true for minorities. Eye witness testimony and video recordings of conflict between law enforcement and persons arrested, beaten or killed have not been accepted as sufficient evidence of abuse for there to be an indictment, trial of law enforcement officers or allow for an impartial review of all the information associated with the incident. Although law enforcement officers are rarely indicted, they are not perceived as innocent by the public. This scenario has created a perception of a legal system that is prejudiced and unjust. The public feels violated and abused by law enforcement, abandoned by the Court and the legal system.

When law enforcement is the victim of a shooting or violence prior corruption and acts of abuse against the public is often used as justification for revenge and violence against them, although the victims may not be the ones who committed the transgressions. In the aftermath, law enforcement often become both more defensive and offensive in their actions and assumes a “us against them” posture and reaction towards the public they are entrusted to protect.

Law enforcement is entrusted with the responsibility of protecting the public. Most law enforcement officers risk their lives every day to perform their duty with honor and integrity. However, there are a small percentage of law enforcement officers that abuse their authority and violate the honor of their profession and the public trust. Unfortunately, the misdeeds of these few are, too often, generalized to the larger group of law enforcement officers and distort the image and reputation of a very noble and honorable profession.

In spite of the aforementioned, it is also true that most of the public recognizes, respects, and depend upon law enforcement to protect them from danger and harm. However, the transgressions of a minority of officers have created an environment of fear and mistrust for a significant portion of the Public.

There is no logical expectation that conflict between the law enforcement and the public will diminish or be amicably resolved at any time in the foreseeable future. In order for there to be any progress towards repairing the credibility of the US Justice System and the relationship between police and the public creative initiatives need to be taken that will be accepted as fair and effective by law enforcement, the public, and the Courts.

### SUMMARY

Termed herein third witness application (TWA), the TWA uses technology to: (1) save the lives of law enforcement officers and the public; (2) reduce the use of excessive force and physical conflict between law enforcement and the public; and (3) establish mutual respect and trust between law enforcement and the public.

The TWA offers specially created features to establish a technology standard of behavior and procedures to be exercised by law enforcement and the public citizen when they come into contact with each other. It is hoped that these features will save lives, minimize the need to use force by law enforcement, improve relations between law enforcement and the public and restore credibility to the US legal system.

TWA is a technology system, computer-implemented method and non-transitory medium for a multi-level video recording process including the step of inviting participation by the alleged perpetrator and a corroborating third party of public representatives.

Accordingly, comprehended is a video recording and law enforcement corroboration process, comprising the steps of establishing a video feed between a law enforcement officer and a perpetrator; noticing the perpetrator of the video feed provided the law enforcement officer has established the video feed; noticing the law enforcement officer of the video feed provided the perpetrator has established the video feed; inviting participation by a corroborating third party; and, sharing the video feed, wherein an interaction between the law enforcement officer and the perpetrator is both documented and corroborated. The feed being recorded thereby forms a record which can be sent to a central processing unit, thereby forming an event record, wherein the event record can be stored and used in criminal proceedings as it relates to the perpetrator.

Structurally, the system includes a video recording and law enforcement corroboration system, comprising a cap to be worn by a user; a clip strip mounted on the cap; a wireless camera accessory secured to the clip strip; and, a harness to be worn by the user, the harness including means for mounting additional wireless camera accessories onto the harness.

### BRIEF DESCRIPTION OF THE DRAWINGS

FIG. 1 shows a front view in elevation of a cap adapted to secure wearable cameras.

FIG. 2 shows a front view in elevation of the cap included a security strip and the wearable camera.

FIG. 3 shows a front view in elevation of a harness.

FIG. 4 is a flow chart of the methodology at the law enforcement level.

FIG. 5 is a flow chart of the methodology at the citizen level.

FIG. 6 shows the process flow of the record created by the citizen and/or law enforcement officer.

FIG. 7 is a flow chart of the methodology at the corroborating, third party level.

### DETAILED DESCRIPTION OF THE PREFERRED EMBODIMENT

The description represents a method with logic or program flow that can be executed by a specialized device or a computer and/or implemented on computer readable media or the like (residing on a drive or device after download) tangibly embodying the program of instructions. The executions are typically performed on a computer or specialized device as part of a global communications network such as the Internet. For example, a computer typically has a web browser installed within the CPU for allowing the viewing of information retrieved via a network on a display device. A network may also be construed as a local, Ethernet connection or a global digital/broadband or wireless network or cloud computing network or the like. The specialized device may include any device having circuitry or be hand-held device, including but not limited to a tablet, smart phone, cellular phone or personal digital assistant (PDA) including but not limited to a mobile smartphone running a mobile software application (App). Accordingly, multiple modes of implementation are possible and “system” as defined herein covers these multiple modes.

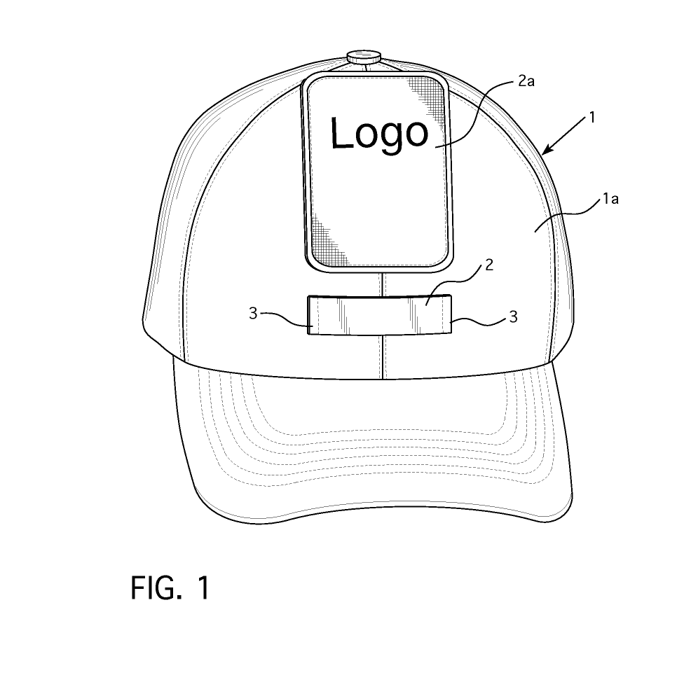

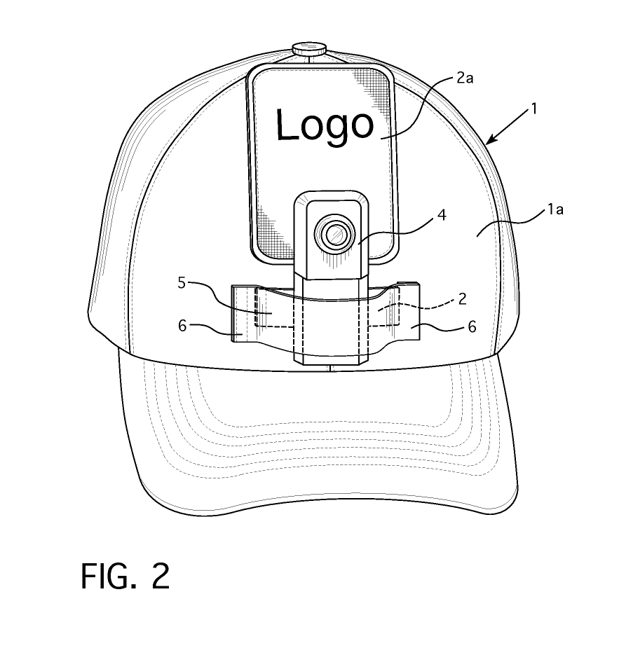

Referencing then FIGS. 1-3, the system comprises, in part, wearable video cameras. More particularly, a cap 1 includes a clip strip 2 and may include a logo patch 2a, the latter serving as an identification means. Clip strip 2 is a piece of material disposed on the cap 1 at either or both of the front 1a and back (not shown) of the cap 1. The clip strips 2 are strips are used to hold cameras and other devices in position for front and rear view recording and communication. By being on both the front 1a and back, both a rear and front feed can be obtained. The clip strip 2 is attached to cap 1 by having its ends 3 stitched or glued to cap 1 as shown. As a result a strap or pocket is formed. Accordingly, wireless camera accessory 4 can be clipped onto clip strip 2. For instance, wireless camera accessory 4 can include a clip or other implement which clips on to clip strip 2. As used herein, “wireless camera accessory” means the wireless camera itself or any component on which a camera is mounted.

A reinforcing security strip 5 is attachable over clip strip 2. For instance, security strip 5, using hook and loop fasteners or the like at its strip ends 6, has its strip ends 6 removably attachable over clip strip 2. In the manner, when wireless camera accessory 4 is inserted through clip strip 2, to aid the securement of the wireless camera accessory 4 the security strip 5 covers the wireless camera accessory 4 to more firmly hold it in place. This is advantageous in light of the possibility of physical altercation by an alleged perpetrator which could potentially jostle or knock the wireless camera accessory 4 out of place. Thus, the security strip 5 on the cap 1 provides unique security for excessive physical activity, apart from common and casual use.

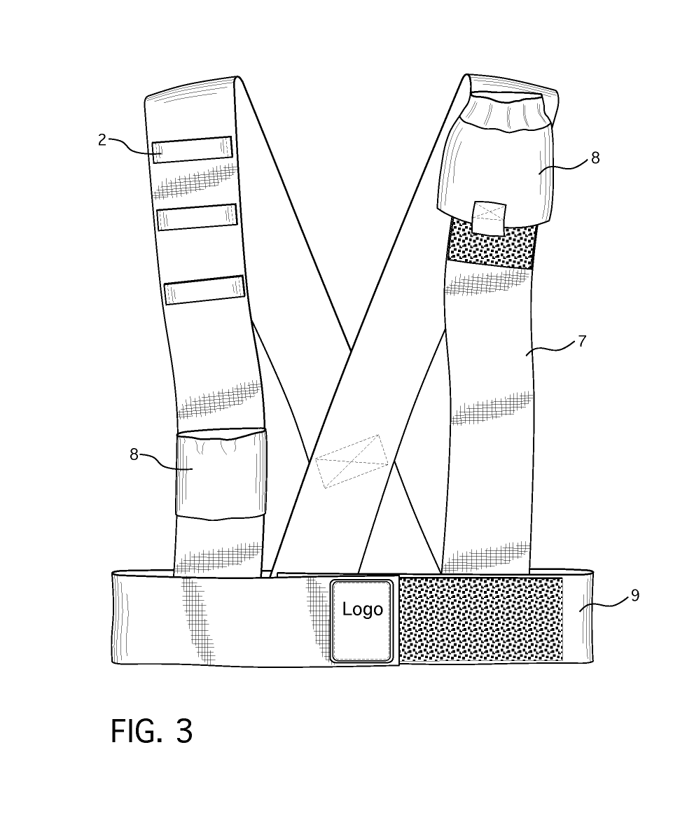

Other wireless camera accessories 4 and clip strips 2 and other implements can be worn at the body of law enforcement officers by providing a harness 7. The harness 7 is depicted by FIG. 3 and shows a variety of pockets 8. Pockets 8 or sleeves are adapted to contain portable battery chargers and accommodate smart phones for instance. Additional clip strips 2 are provided. It should be understood that the location of each pocket 8 or clip strip 2 can vary, even be provided at the back. The harness 7 is designed for use by police and the public and easily be adorned using waist belt 9 over any uniform, attachments, casual or seasonal attire. The harness 7 is especially designed for use by police and the public while driving.

Thus, wearable cameras are being proposed to be worn by law enforcement officers to record their interaction with the public. “Law enforcement officer” means any individual whose duties primarily involve the enforcement of laws and who, by way of that authority, can approach a citizen of the general public for questioning. The phrase can include police officers, special police officers, customs officers, state troopers, special agents, special investigators, border patrol officers, immigration officers, court bailiffs, correctional officers, probation officers, parole officers, arson investigators, auxiliary officers, game wardens, sheriffs, constables, marshals, and deputies. The public would be an individual citizen of the general public. An individual who may be approached and questioned by law enforcement would therefore be an alleged “perpetrator” of the act in question, whether legally in violation of the law or not. So the one-way communication is between the law enforcement officer and the perpetrator. “Corroborating third party” is the third or more individuals or group of individuals who are conferenced in to witness the communications, gestures, or other acts between the law enforcement officer and the perpetrator. So the instant “Third Witness” application includes a video conferencing capability and other technological features that encourage communication between both law enforcement and public and more objectively “documents” the contact and ensuing events and “corroborates” same.

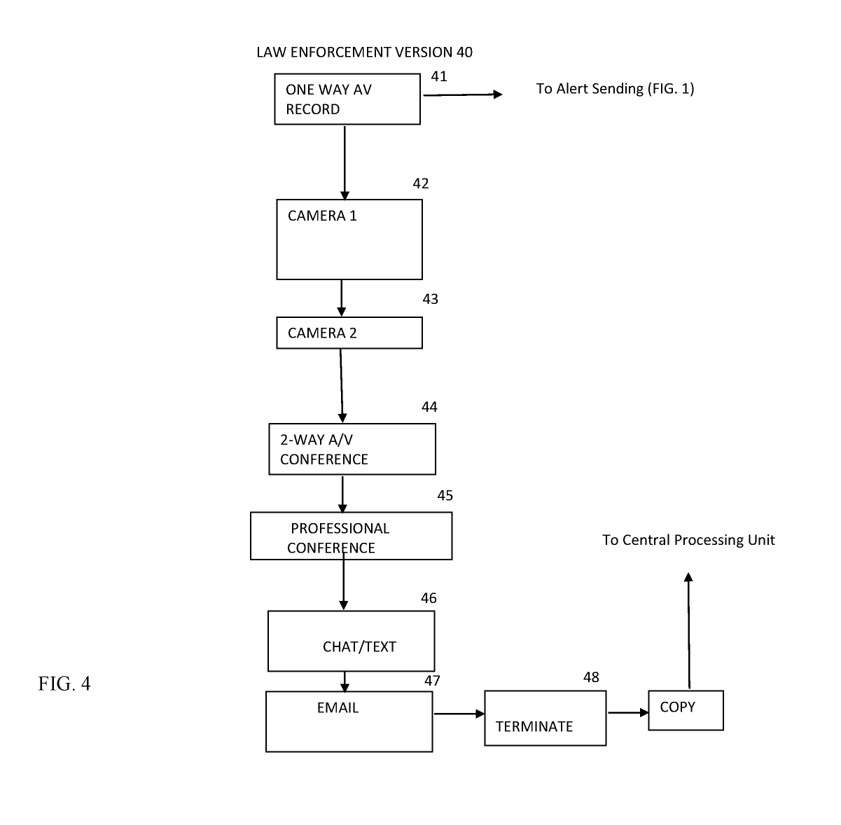

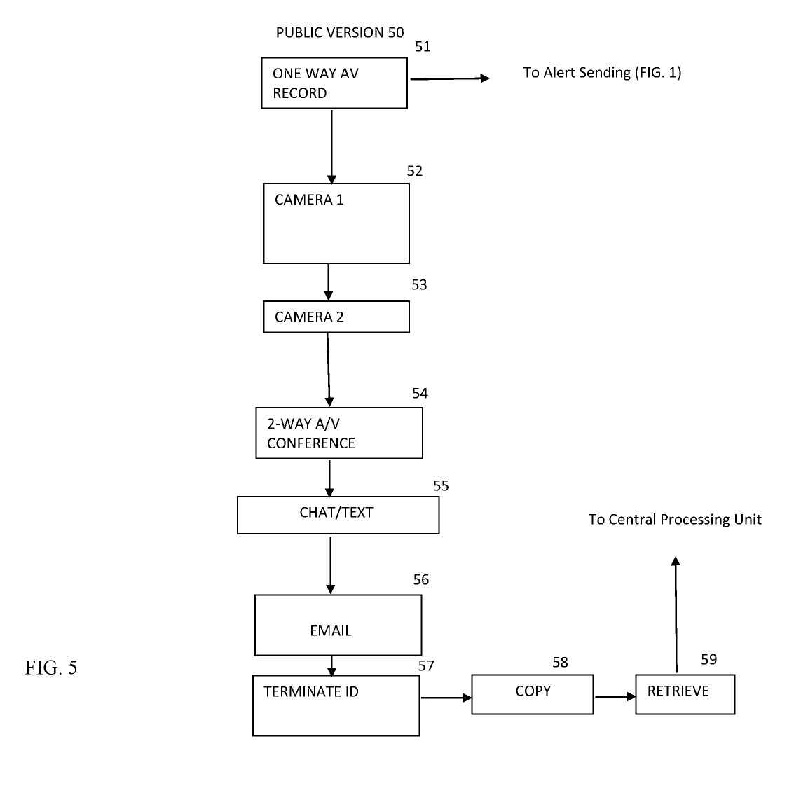

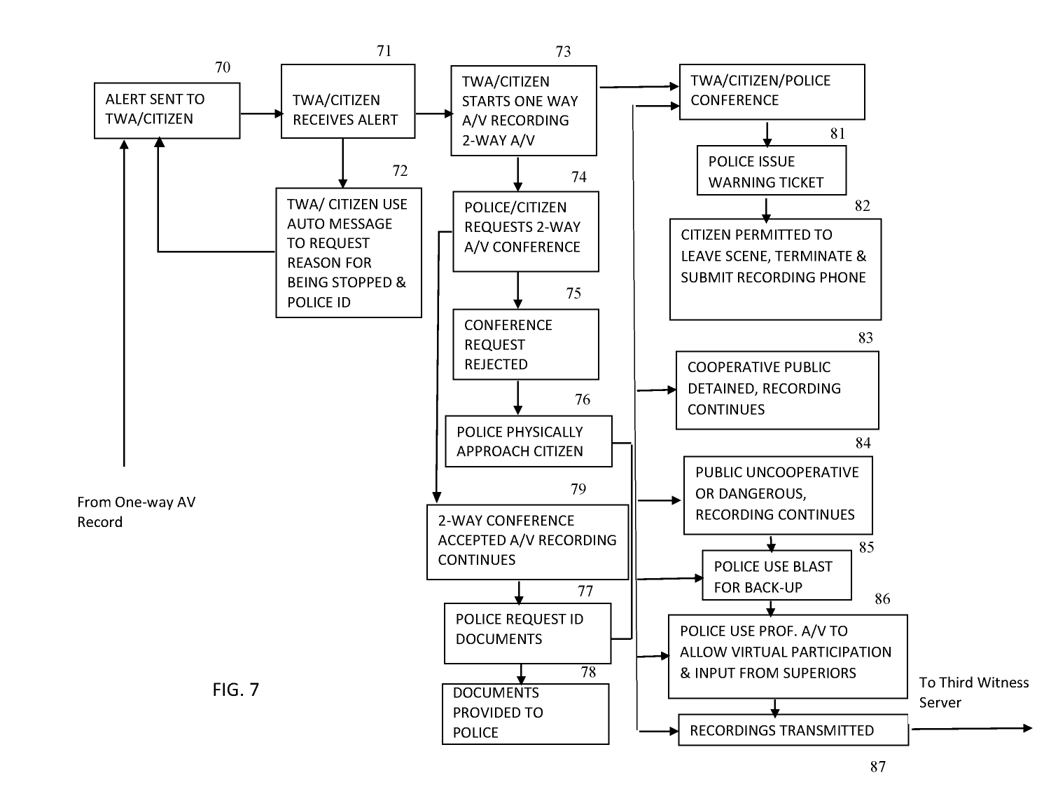

Referencing then FIGS. 4-7, shown is the instant methodology performed, for instance, with an accompanying mobile software application available on smart phones and other mobile devices which includes a law enforcement version 40 (FIG. 4) and a public version 50 (FIG. 5). Critically, either version is configured to use two-way interactive video conference and recording (rather that one-way video recording) between law enforcement and the public with date, time and location as part of the record. Law enforcement officer creates a video feed to thereby creates one way a/v record 41 using camera (1) one 42 and/or camera (2) two 43. Law enforcement officers will be able to remotely communicate, screen identify driver, verify their documents, and view and search vehicles without being exposed to physical harm and violence. Next, the law enforcement officer can share the feed by initiating two-way conference 44 to allow for participation of the video recording process by third person participants, law enforcement, supervisors, attorneys or the public monitoring from a remote location, for instance by conferencing in professional 45. “Inviting participation” means a share of the actual feed, real-time or not, or a sharing of the recorded feed with the third party participant or reviewer. The sharing function also allows for the sharing of not only the feed, but communication forms such as chat/text 46 and email 47.

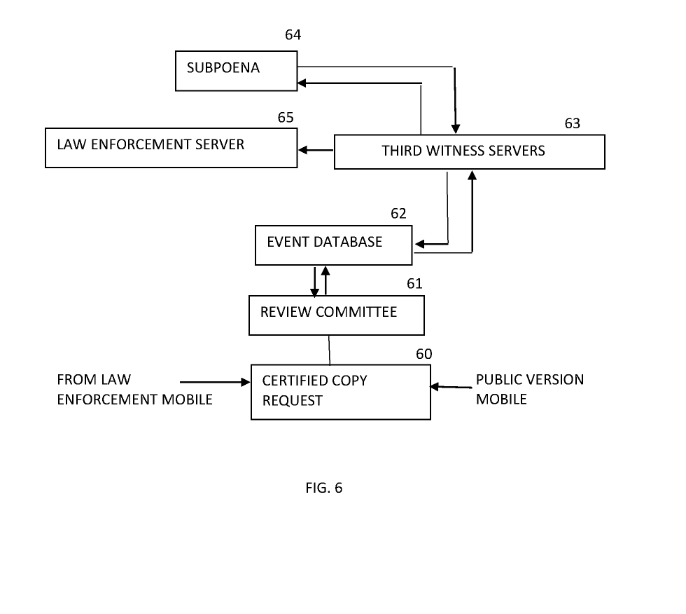

After any interaction session is terminated 48, all recordings can be copied 49 and be assigned a case number and stored on servers maintained and managed by a central processing unit and an impartial review board comprised of law enforcement, public and community leaders. This board will be charged with the review of the recordings to verify their integrity. For instance, referencing FIG. 6, integrity certification and potential use in proceedings involves a central processing unit receiving a copy 60 of the recorded feed, reviewing potentially through a committee 61, compiling an event database 62 to create the case number, and storing the case on the central processing unit/third witness server 63, which as an authenticated file that can be subpoenaed 64 and/or stored on a law enforcement server 65.

FIG. 5 depicts the public version 50 of the instant methodology performed, for instance, with the public version App. All steps are similar to the law enforcement version with the exception that a professional conference would not be in order, and here the citizen can initiate the conference. Thus, in a similar manner, a citizen creates a video feed to thereby create one way a/v record 51 using camera 1 52 and/or camera 2 53. For the protection of the citizen, a citizen can “invite participation” and share a copy of the recordings 54 to allow for review of the video recording process by third person participants. The sharing function also allows for the sharing of not only the feed but communication forms such as chat/text 55 and email 56. After any interaction session is terminated 57, all recordings can be copied 58 and be assigned a case number and stored on servers maintained and managed by a central processing unit and an impartial review board comprised of law enforcement, public and community leaders per the above for retrieval 59.

So a record can be created by both a citizen and law enforcement personnel and if initiated by either, then the other is notified as such. During any altercation, e.g. the citizen is now an alleged perpetrator, an alert is sent to the third person witness 70 by the police. The third person witness receives the alert 71 and requests reason for the stop 72, unless already provided by the law enforcement officer. Third party witness then begins recording 73. Two (2)-way conferences can then be requested by either the citizen or the law enforcement officer 74. The request can be either accepted or rejected. If rejected 75, then the law enforcement officer approaches the citizen as in the normal course 76, i.e. asks for and receives identification documents (ID) from the citizen 77, 78. If the request for a two-way conference is accepted, the recording continues 79. As part of the two-way recordation, the conference actually accompanies any issuing of ticket or warning process, 81, after which the citizen is permitted to leave the scene, the conference is terminated and the recorded feed can be submitted to the central processing unit 82 and retained. In a similar manner, if there is an actual detainment, cooperative or not 83, 84, the law enforcement officer can “blast” for back-up 85, call in other personnel to the conference 86, then submit the recording 87 to the central processing unit, i.e. third witness server.

In summary, any board would confirm the integrity of the final recordings submitted and stored and that it accurately represents the event of interest (i.e., verbal communications, physical arrests, shootings, etc). Via GPS, the recordings verify the identity, date, time, and location of the law enforcement, person of interest, and other relevant parties at the time of the incident or event. The application contains certain standard features and prompts such as picture ID, copy of the person's driver's license and insurance information, pre-scripted auto greetings (such as “hello officer, my name is “Joe Public” may I ask why I am being stopped or arrested? “Am I free to go?”). The application would be available to all law enforcement with a smart phone or other mobile device. Envisioned is that the “Third Witness” would be viewed as impartial and a mutually beneficial means of communication and alternative behavior between law enforcement and public. It should serve as a deterrent from any variation of proper and legal procedure and use of violence by law enforcement as well as disrespect, unlawful and violent behavior perpetrated by the public.

I claim:

1. A video recording and law enforcement corroboration process, comprising the steps of:
establishing a video feed between a law enforcement officer and a perpetrator;
noticing said perpetrator of said video feed provided said law enforcement officer has established said video feed;
noticing said law enforcement officer of said video feed provided said perpetrator has established said video feed;
inviting participation by a corroborating third party; and,
sharing said video feed, wherein an interaction between said law enforcement officer and said perpetrator is both documented and corroborated.

2. The process of claim 1, further comprising the step of recording said video feed, thereby forming a record.

3. The process of claim 2, further comprising the step of sending said record to a central processing unit, thereby forming an event record, wherein said event record can be stored and used in criminal proceedings as it relates to said perpetrator.

4. A video recording and law enforcement corroboration system, comprising:
a cap to be worn by a user;
a clip strip mounted on said cap;
a wireless camera accessory secured to said clip strip; and,
a harness to be worn by said user, said harness including means for mounting additional of said wireless camera accessories onto said harness.

5. The system of claim 4, further comprising a reinforcing security strip attachable over said wireless camera accessory and on to said clip strip.

6. The system of claim 4, wherein said wireless camera accessory is a smart phone.

7. The system of claim 4, wherein said wireless camera accessory is a wearable camera.

8. The system of claim 4, wherein said wireless camera accessory is a battery charger.

9. The system of claim 4, wherein said harness further includes one or more pockets.

10. The system of claim 4, wherein said harness further includes one or more of said clip strips.

11. The system of claim 4, wherein said clip strip is at a front of said cap.

12. The system of claim 4, wherein said clip strip is at a back of said cap.
